(19) United States
(12) Patent Application Publication
(10) Pub. No.: US 2008/0147206 A1
(43) Pub. Date: Jun. 19, 2008

(54) Control system for Real Time Applications for Cooperative Industrial Robots

(75) Inventors: Said Zahrai, Vasteras (SE); Matthias Karlsson, Vasteras (SE); Jorgen Gade, Vasteras (SE); Per Carlsson, Vasteras (SE)

Correspondence Address: VENABLE LLP, P.O. BOX 34385, WASHINGTON, DC, 20043-9998, US

(73) Assignee: ABB AB, Vasteras (SE)

(21) Appl. No.: 11/661,370

(22) PCT Filed: Aug. 10, 2005
(86) PCT No.: PCT/SE05/01198

§ 371 Date: Dec. 17, 2007

(30) Foreign Application Priority Data
Aug. 30, 2004 (SE) 0402098-8

(51) Int. Cl. G05B 19/02; G05B 19/048

(52) U.S. Cl. 700/19

(57) ABSTRACT

A control system adapted for real time applications for carrying out the following functions: communication, control of a process or a device, and safety functions. The control system includes a plurality of function modules adapted for at least carrying out the control function and the safety functions. Each function module is adapted for receiving input data and for providing output data. Each function module is adapted to carry out a defined task based on the received input data and provide output data based on the task carried out. Each function module is adapted to carry out the task during a time period, which is independent of what is simultaneously going on in the other modules. At least one of the function modules has its logical components implemented on a programmable logic device.

### FIELD OF THE INVENTION

The present invention relates to a control system adapted for real time applications according to the preamble of Claim 1.

Such a control system comprises means for handling a plurality of different functions, such as communication with external systems, communication with an operator, control of a process or a device, and safety functions.

A control system according to the invention is advantageously used in any control system adapted for real time applications, but it is particularly advantageous for use in control systems adapted for motion control, and most particularly advantageous for use in control systems adapted synchronized motion control, such as control of industrial robots. Motion control refers to generation of a controlled movement of a system constituting movable parts. If the motion of movable parts is not independent, synchronization is needed to achieve desired movement. This is referred to as synchronized motion control.

### PRIOR ART

Traditionally, such a control system comprises computer programs for handling different functions, such as communication with external systems, communication with an operator, control of a process or a device, and safety functions. One or more high-speed processors execute the computer programs. In most cases, the functions are fictively performed in parallel by means of an operating system.

A computer program is structured in different tasks. A task is a sequentially arranged program and performs a predetermined function. In a real-time operating system, the tasks are given mutually priority and if two tasks are to be executed at the same time by the processor, the task with the highest priority is executed first. This means that a task with low priority has to stand back for tasks with higher priority and there is a risk that some tasks with low priority will never be handled.

Real-time systems are different from most other systems, since they are tremendously sensitive to disturbances in the timing. Typical for a real-time control system is that it should be deterministic, meaning that it shall always be predictable. Thus, it is preferable in a real-time control system that the time period for performing a certain task always is the same, independent of when it is performed and what other tasks are. This can never be achieved when different tasks are sharing the same processor and are run fictively in parallel using a real time operating system. However, if the speed of the processor is high enough it is possible to guarantee that the time period for performing a certain work always is less than a certain time limit. For example it should be guaranteed that if the operator activates the emergency brake the robot should be stopped within a well-defined time limit. A problem in connection with real-time control systems of today using a single powerful processor is the high cost of its hardware.

Hereinafter a typical control system of today, with an automated process controlled by different agents at various levels will be described. The process to be controlled can be continuous, discrete or mixed continuous and discrete. Here, it is assumed that the process takes place in a number of stations, here referred to as cells. Each cell contains a number of machines that together perform the task associated to the cell. A machine is a system made of a suitable combination of devices such as electrical motors, pumps and valves that act together in a synchronized manner. Typically, such a machine receives commands from a device, a so-called cell controller responsible for controlling the cell. A PLC is often used as cell controller.

A machine in a working cell communicates with other machines in the same cell either through the cell controller, through a direct link or through a bus communication. In particular, other smaller system might exist that can be considered as a sub-system to the mentioned machine. A controller for the machine, a so-called machine controller, has usually the capacity of controlling minor external sub-systems as well.

As an example, one might consider a working cell in an automobile production line. Such a cell includes a number of industrial robots for performing the work. These robots usually have a control cabinet each, which is programmed to control the robot in order to execute necessary tasks. More powerful controllers are also able to control external devices such as positioners or even more than one robot simultaneously. A powerful machine controller could also include functionalities necessary for control of the whole cell. In this case, the cell controller is integrated with the machine controller.

An operator needs to program and supervise the system. This can be and is usually done at different levels. The cell controller is used for task planning at a higher level while the machine controller is used for direct interaction, supervision and programming of the machine itself and its sub-systems.

Any system that interacts with human should guarantee that the risk for hazardous accidents is at a minimum level. Therefore, the machine controller usually offers at least certain minimum safety functionalities such as detection of activation of the emergency brakes, detection of increased temperature at sensitive points and detection of malfunction in parts with an effect on safety issues. For processes with especial safety requirements, external devices can be used.

To conclude, to offer a complete functionality, the system has to take care of continuous, regular and time-accurate tasks such as control of the movement of an industrial robot, simultaneously as supervision and response to discrete and sometimes irregular events such as following commands from the cell controller and response to emergency signals. These functions, namely continuous or discrete process control and safety functions are to be completed by communication devices with the operator and the cell controller in order to offer a complete system for control, supervision and programming of the machine with possibility of integration with other devices in the cell.

Today's controllers are mainly based on use of digital processors for control of the process, communications and discrete event handling. As an example, a robot controller contains a hardware including the mentioned processor, devices for measurement of the position of each axis, communication devices for communication with the operator and factory network, devices for field-bus communication for communication with other devices and devices for safety arrangement. In addition to that, for example if the robot is equipped with permanent motors, a drive system, fed by a DC current from a rectifier, is used in order to supply the motors with correct current and voltage.

Due to the real-time requirements in the range of micro seconds, a powerful processor is needed if all of the computational work, safety and supervision are to be done on the same processor. In that case, the cost for the system becomes an issue and the solution will not be acceptable. A common solution to that is to divide the system into separate units each of which usually implemented on separate boards including computational power and other necessary peripheral devices. In order to make the system cost efficient, the system should be optimized with respect to communication between these units.

In a robot controller, one may have a first unit responsible for high level activities such as interaction with operator, communication with the external devices, path planning and interpolations. The first unit, which is at the highest level, includes also safety functionalities and it communicates and controls other parts at the lower level. A second unit, which can be a motion board, is responsible for the motion of the axis of the robot. For example, after path planning, the reference position and speed are sent to the second unit for further computations.

The second unit receives command and data from the first unit and computes the necessary torque for reaching the target position at required speed. The resulting torque is usually updated at a higher frequency than that of the received reference data from the first unit. The torque is further sent to a drive which uses this value as a reference to compute the pulse modulation width (PWM) signals to be sent to the power transistors in order to force the motor to deliver the required torque. These values are updated at considerably higher frequency than that of received torque references.

Although the primary assignment for both the motion board and the drive is to perform the computation necessary for the system to follow the pre-computed path, they also have to respond to discrete events related to external signals, such as commands form an external system, detection of activated emergency stop or internal warning signals such as a too high temperature in a given sensitive point.

In today's system, to be able to respond to discrete events while a computational task is executing, a more powerful processor must be used. The processor executes software where different activities are organized as a number of tasks. These tasks are initiated at the start time and are active simultaneously but are executed one at a time on the processor according to a scheduling scheme and priorities. One may consider the tasks as being fictively parallel.

A prior art control system for an industrial robot is disclosed in Swedish patent application no. 0201761-4. The control system comprising a plurality of physically separated modules adapted for handling different functions, each module having its own power supply and computer power and is provided with an interface for communicating with each other. The main computer, the axis computers, i.e. the first and second units mentioned above, and the drives are located in different modules. Each module is provided with a casing. The aim of this control system is to make it possible to locate the modules at physically separated places, and thereby optimize the use of limited available space in the robot cells. Even though not explicitly expressed in the application, the control system disclosed is of a traditional architecture using digital processors with operating systems for handling the different tasks in a fictively parallel manner.

It is known to use Field Programmable Gate Arrays (FPGA) for execution of an application program in automation and control applications. A single FPGA chip contains an array of thousands of logic gates whose interconnections can be configured by writing appropriate commands to its internal memory. One of the advantages of using FPGA is that function blocks can be developed, packaged and made available for general use in larger system as so called IP-cores. For example, it is known that digital signal processor can be implemented as on FPFA and will be available as IP-cores, in the following denoted a soft processor core. Nios from Altera Corporation and MicroBlaze from Xilinx Inc. are examples of commercially available soft processor cores that are currently used in simple applications.

A Japanese patent no 2001322078 discloses a control system for an industrial robot. A hardware device is proposed for actuating the operating parts of a robot, which includes a drive system comprising programmable logic, such as an FPGA, for supplying voltage drive circuits with control signal and for executing an application program. This document does not treat the general control device for an industrial robot but focuses on a solution for control of axis movement at low level. Communication between the part mentioned in the document and the other parts of the controller, as well as other necessary functionalities such as safety issues are not considered.

### OBJECTS AND SUMMARY OF THE INVENTION

The present invention aims at achieving an improved control system suitable for real time applications. The invention particularly aims at providing a control system which requires hardware that is less expensive than traditional control systems but with comparable performance.

This aim is achieved by a control system comprising the characterizing features of claim 1.

The cost for a control system according to the invention is reduced thanks to the fact that is has an architecture, which allows an increase in the level of integration. The invention makes it possible to implement most of the control system by means of programmable logic and thus the cost for hardware will be reduced. To be able to do that in a structured manner, the system is partitioned to a number of function modules, which are possible to implement by means of programmable logic. These modules are run simultaneously and in a real parallel manner. Thus, no operating system or other means for scheduling of execution of simultaneously active tasks is needed. For instance, fault tracing is simplified.

Each function module comprises an interface for receiving input data and for providing output data and is adapted to carry out a defined task based on said received input data and to provide output data based on the result of the task carried out. Each function module is adapted to carry out the task during a time period, which is independent of what is simultaneously going on in the other modules. Preferably, each function module is adapted to carry out the task during a time period, which only depends on the input data to the module. Thus, real time characteristics are guaranteed. The time period for performing a task is always the same independent of when and under what global circumstances it is performed. Accordingly, the timing of the control system is predictable. If a new function module is added to the system, the time period it takes for an existing function module to perform a task upon receiving input data is still the same. Thus adding new functionality to the system does not influence the timing of the function modules.

According to a preferred embodiment of the invention each function module comprises all components necessary for carrying out the defined task. Thus, each function module is a complete and independent subsystem of the control system, and is capable of performing its task independent of the other modules even though all the other function modules are turned off.

Preferably, most functions in the control system are implemented by means of function modules. Since, the time aspects are particularly important for the control function and the safety function, at least those functions should be implemented as function modules. One main function, such as the control function, or safety function, could advantageously be implemented by more than one function modules. It is also possible to divide a main function into sub-functions and implement sub-functions from different main functions together in the same function module. For example the safety function may be divided into a plurality of sub-safety functions and they are implemented together with other main or sub functions in the same function module.

According to a preferred embodiment of the invention at least one of said function modules is adapted for carrying out the control function, and at least one of said function modules is adapted for carrying out the safety functions, to enable parallel processing of said safety functions and said control function. This embodiment ensures that the safety and control functions are run in parallel and thus that error signals and interruption signals, for example activation of the emergency brake, receive immediate attention and is instantaneously taken care of.

According to a preferred embodiment of the invention one or more of the function modules are adapted for carrying out communication with external systems and communication with an operator. Preferably, at least one function modules is adapted for carrying out communication with external systems, and at least one function modules is adapted for carrying out communication with an operator, to enable parallel processing of communication with external systems and communication with an operator. This embodiment ensures that the functions, communication with external systems and with an operator, are run in parallel. It is highly advantageous to run functions in parallel, since it is fast and the timing for carrying out the function is predictable. When tasks are run in parallel, one can be sure of that all tasks will be carried out immediately and independently of any priority. There is no risk that a task is never carried out or has to wait an unacceptable time before it is carried out, due to a low priority, as is the case in a system where tasks are carried out sequentially in dependence of its priority.

According to the invention at least a part of at least one of the function modules is implemented by means of programmable logic. For example, the programmable logic is provided on one or more field programmable gate arrays (FPGA). In an embodiment of the invention, the entire function module is implemented by programmable logic. It is preferable to implement as many as possible of the function modules by means of programmable logic. Preferably, at least the logical components of the function module are implemented by means of programmable logic. Advantages gained by implementing the modules by programmable logic is that the hardware required is cheap, it makes it easy to modify the modules, and new functions can easily be added to an existing control system. Implementing the modules by programmable logic makes it possible to integrate the control system on one or only a few chips and thereby saving space and reducing the cost of the system.

According to an embodiment of the invention, at least one of said modules is implemented by means of a state machine providing a defined output for a given input.

In an alternative embodiment at least one of said functional modules is implemented by means of central processing unit (CPU) and application software, which executes the defined task when run on the central processor unit. Preferably, each of the functional modules comprises one central processing unit (CPU) and application software.

According to a preferred embodiment of the invention, at least one of the functional modules comprises a central processing unit implemented by means of a soft processor core implemented on said programmable logic. There are commercially available soft processor cores provided for implementation on a programmable logic, for example on an FPGA. Soft processor cores are flexible, inexpensive and easy to implement. Soft processor cores reduce the cost for development of a new module, make changes easier and shorten development time.

According to a preferred embodiment of the invention, the application software is stored on an FPGA. Preferably, the application software is stored on the same FPGA as the soft processor is implemented on. Thus, fast memory access is achieved, thanks to the short distance between the processor and the memory on which application software is stored and use of fast on-chip busses.

According to a preferred embodiment of the invention, at least one of said functional modules comprises a central processing unit implemented by means of a hard processor core. A hard processor core can handle larger computational load than a soft processor core. Thus, it is advantageous to provide some of the functional modules, which carry out large computations, with a hard processor core. If hard processor cores are available on the same chip as the FPGA, it is advantages to use them to improve the computational performance of the control system.

According to an embodiment of the invention, the system is adapted for controlling an industrial robot and said function modules include one or more function modules for handling position control of the motors of the robot and for handling the safety functions of the robot.

According to an embodiment of the invention, said function modules include one or more function modules for planning the robot path.

According to an embodiment of the invention, said function modules include one or more function modules for model-based control of the robot.

According to an embodiment of the invention, said function modules include one or more function modules for producing drive signals to the motors of the robot.

To reduce hardware costs and number of contacts, it is preferable to locate as many function modules as possible on one single chip. Preferably, at least two of the function modules are located on one single chip, and more preferable at least three function modules are located on one single chip. Preferably, at least the greater part of the function modules are located on one single chip. Thus, depending on the size of the control system and capacity of the chosen chips the function modules are located on one or more chips.

According to an embodiment of the invention, the system comprises a main bus and the function modules are connected to the main bus. Preferably, each of the module interfaces comprises a register unit receiving and storing input data to the function module and output data from the function module. The register unit protects the modules from disturbances from irrelevant communication on the main bus. All communication between the function modules is carried out on the main bus and via the register units. All modules are allowed to communicate with all the other modules. Such a system is easy to build and it is easy to add more modules to the system.

According to an embodiment of the invention the control system comprises a master module adapted for controlling and supervising the function modules. The master module controls all communication between the function modules, thereby being responsible for providing them with input data and retrieving output data from them. Preferably, the master module is connected to the main bus and controls the communication on the main bus. Thereby, collisions on the bus and during reading and writing to the register units are avoided. Since all function modules are receiving commands from the master module, their structure and possibly their software application becomes simplified. Development of function modules becomes more convenient and the system is easy to update and upgrade.

According to an embodiment of the invention the master module, the main bus and at least two of the function modules are located on one single chip. Advantages gained by this embodiment are lower costs, space-savings and less power consumption.

According to an embodiment of the invention, the system comprises a plurality of communication links, and each function module is connected to at least one of the other function modules via one of said communication links. In this embodiment, no master module is required, and an efficient communication between the communication modules is achieved.

### BRIEF DESCRIPTION OF THE DRAWINGS

The invention will now be explained more closely by the description of different embodiments of the invention and with reference to the appended figures.

FIG. 1 shows an example of a function module

FIG. 2 shows a control system according to a first embodiment of the invention.

FIG. 3 shows a control system according to a second embodiment of the invention.

FIG. 4 shows a control system according to a third embodiment of the invention.

FIG. 5 shows a control system according to a forth embodiment of the invention.

FIG. 6 shows an example of functional module for communication with external systems.

FIG. 7 shows an example of a functional module for communication with an operator.

FIG. 8 shows a first example of a functional module for control of axis motion.

FIG. 9 shows a second example of a functional module for control of the motion of an axis.

FIG. 10 shows an example of a functional module for safety functions.

### DETAILED DESCRIPTION OF PREFERRED EMBODIMENTS OF THE INVENTION

The present invention has the goal of reducing the cost of the controller by increasing the level of integration. At the highest level of integration, the whole controller, including interface for communication with the cell controller, device for communication with the operator, control function and safety function, is implemented on a few FPGAs. To be able to do that in a structured manner, the system is partitioned into a number of modules that are placed on the FPGA. These modules are run simultaneously and in a real parallel manner.

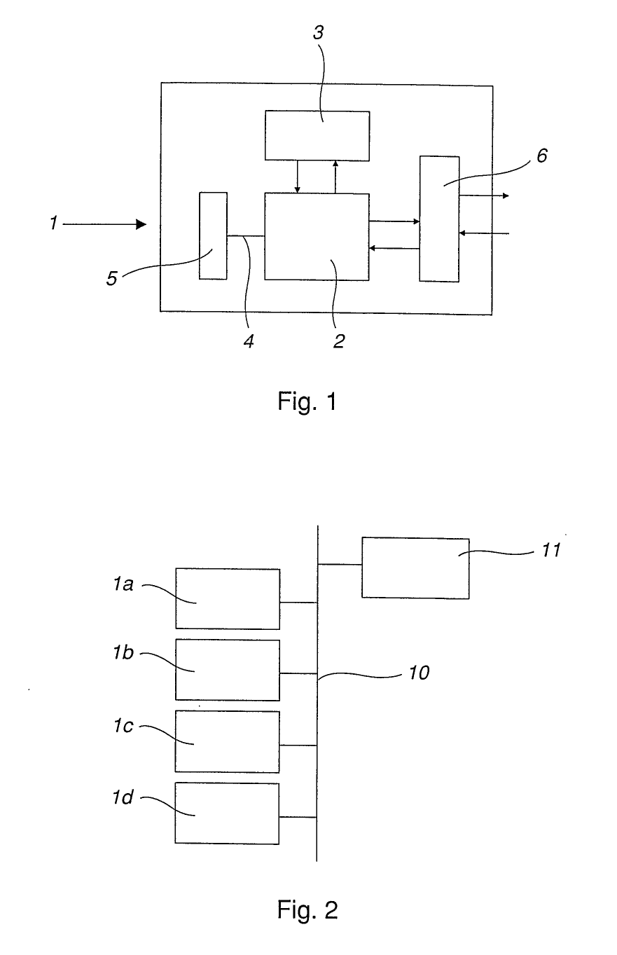

Each module is implemented with the technology and the structure mostly suitable for its task and has an interface allowing communication to and from the module in a controlled manner. FIG. 1 shows an example of function module 1, comprising a central processing unit (CPU) 2, an internal memory 3 for storing an application program, a local bus 4, various components 5 necessary for carrying out its assigned task, and an interface 6 for receiving input data and for publishing output data. The interface comprises for example a register. The function module is adapted to carry out its defined task based on input data received via the interface and to provide output data based on the result of the task carried out. The function module is adapted to carry out the task during a time period which only depends on said input data, and which is independent of what is simultaneously going on in the rest of the control system.

To offer a complete function, the function modules must be in contact with each other. There are several possible configurations for interconnecting the modules to provide necessary communication between them.

FIG. 2 shows a control system according to a first embodiment of the invention. The control system according to this embodiment comprises a plurality of function modules 1a-1d, a main bus 10 and a master module 11. The function modules 1a-1d and the master module 11 are connected to the main bus 10. All function modules are considered as slaves that receive input data and commands from the master module and make its results available through their interfaces to the master module. The master module has all information about how the modules function and what input and output they have. The master module is adapted for controlling and supervising the function modules, for controlling the communication on the main bus, and all communication between the function modules.

Each function module is run independent of the other function modules. Each function module 1a-1d comprises an interface for communicating with the other function modules through the master module. For example, the task of function module 1a is communication with external systems, the task of function module 1b is communication with an operator, the task of function module 1c is control of a process or a device, and the task of function module 1d is performing safety functions of the control system.

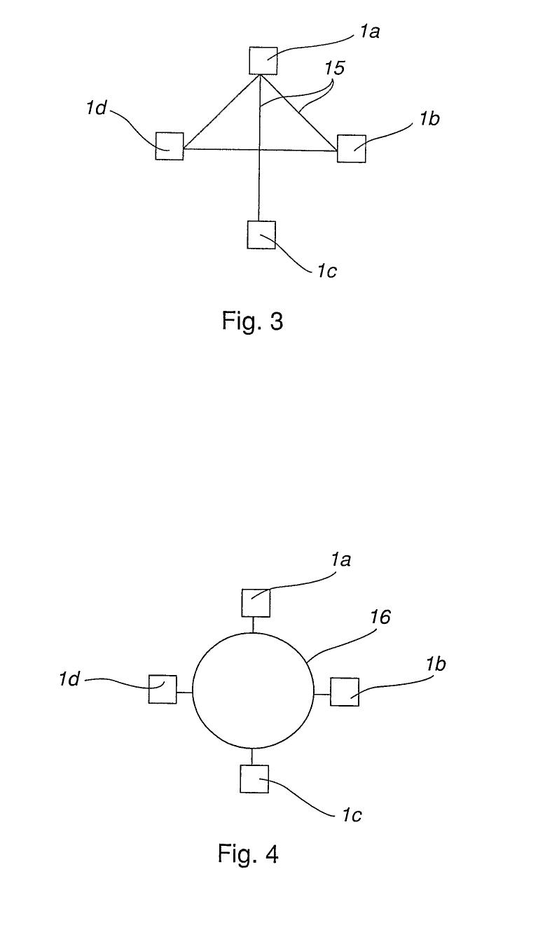

FIG. 3 shows a second embodiment of a control system according to the invention, comprising a plurality of communication links 15. Each function module only is put in contact with those modules it needs contact with. The links 15 between the modules can be directional and fast.

FIG. 4 shows a third embodiment of a control system according to the invention, comprising a main bus 16 and the function modules 1a-1d are connected to the main bus. All modules are put in contact to each other with an address associate to each module. Every module could then send its output to the module requiring the data.

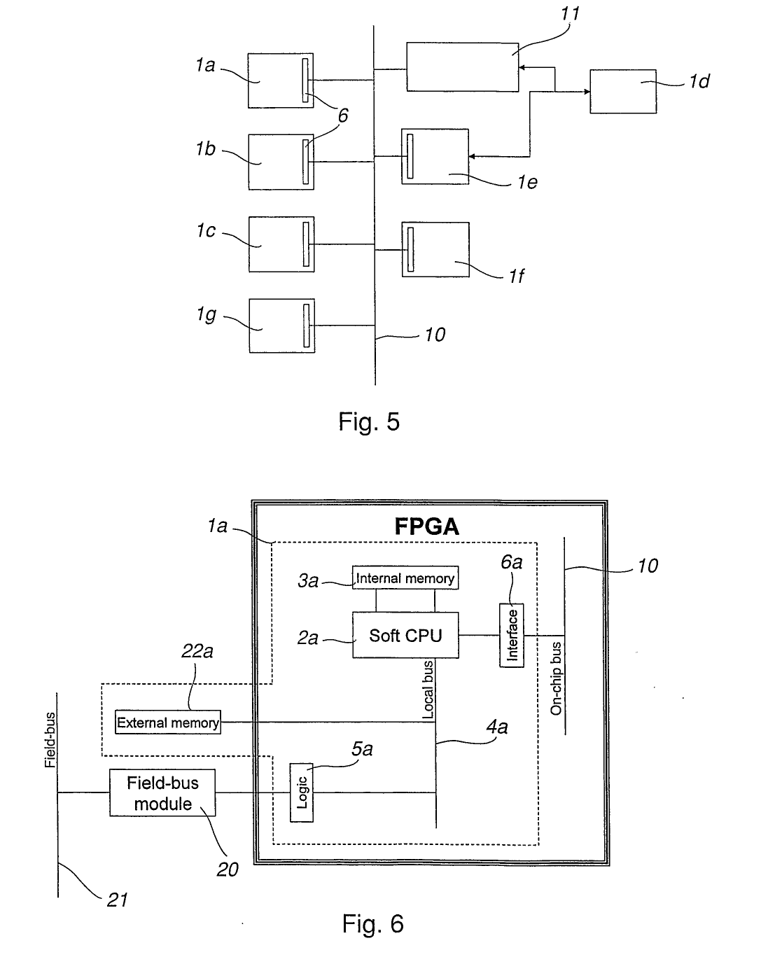

As a configuration, the modules can be arranged according to a combination of the above methods in order to achieve the maximum performance with an easily scalable system. FIG. 5 illustrates such a control system, according to a forth embodiment of the invention. The control system comprises a plurality of function modules 1a-1g, a main bus 10 and a master module 11. As an example, function module 1e is a path planner, function module 1f is an internal device, and function module 1g is a sub system. The function modules 1a-1c, 1e, and 1f and the master module 11 are connected to the main bus 10. The safety module 1d has direct link to the master module 11 and to the path planner module 1e, while the other modules are as slaves with their interfaces 6 connected to the main internal bus 10 controlled by the master module 11. The direct link between the safety module and the path planner offers the possibility of quick soft stopping function while the direct link between the safety module and the master module provides the immediate emergency stop function as a part of the main safety.

In the following a number of examples of function modules will be described in more detail. The examples refer to a control system for an industrial robot.

The traditional method for providing the communication with the external system is to provide the possibility to add an optional circuit board for field bus communication and software for translation of received commands or transmission of commands. In a one-processor system, where the processor is also responsible for other tasks, the communication takes place according to its level of priority set at the level of the operative system.

FIG. 6 shows an example of functional module 1a for communication with external systems, such as cell controller, through a field bus. In the present invention, making use of a separate functional module with respective software and hardware solves this problem giving a higher degree of performance. Firstly, a hardware module, in this example a field-bus module 20, that gives a correct signal interface to the world outside will be added. If the system is developed for a specific field bus 21, the field-bus module 20 can be a permanent part of the system. Otherwise, it can be exchangeable resulting in flexibility of adaptation to the field bus used in the system.

The controller accesses the field-bus module through a logical block 5a. This logical block 5a, which is similar to logic for memory access and can be consider as a separate IP-core, is placed on the FPGA. Once such an IP-core is placed on the FPGA, the signals are accessible by the controller. A soft processor 2a is then used for execution of the software for translation of the signals. Communications between the logic block 5a and the soft processor 3a are taking place on a local bus 4a that allows a high level of exchange of information without causing any disturbance to the rest of the system. The application software and data for the purpose of communication with an external system can be stored on the internal memory 3a on the FPGA, on the external memory blocks 22, or on both.

After a complete set of communication, including the message that should be passed and handshaking in order to ensure the correctness of data transmitted, the software executed on the soft processor will decode the message. The part of the message that should be visible to the rest of the controller will be made available for the system. For messages of high degree of urgency, the module can also generate an interrupt signal. The module 1a communicates with the main bus 10 through an interface 6a.

This module runs in parallel to the whole system and therefore field communications do not increase the load on the system and do not risk generating any difficulties for time-accurate operations taking place in the system.

Today's robots include a separate device to allow the user to manipulate them, program them or follow the actions of the robot and in the case of failure look for the cause of the problem.

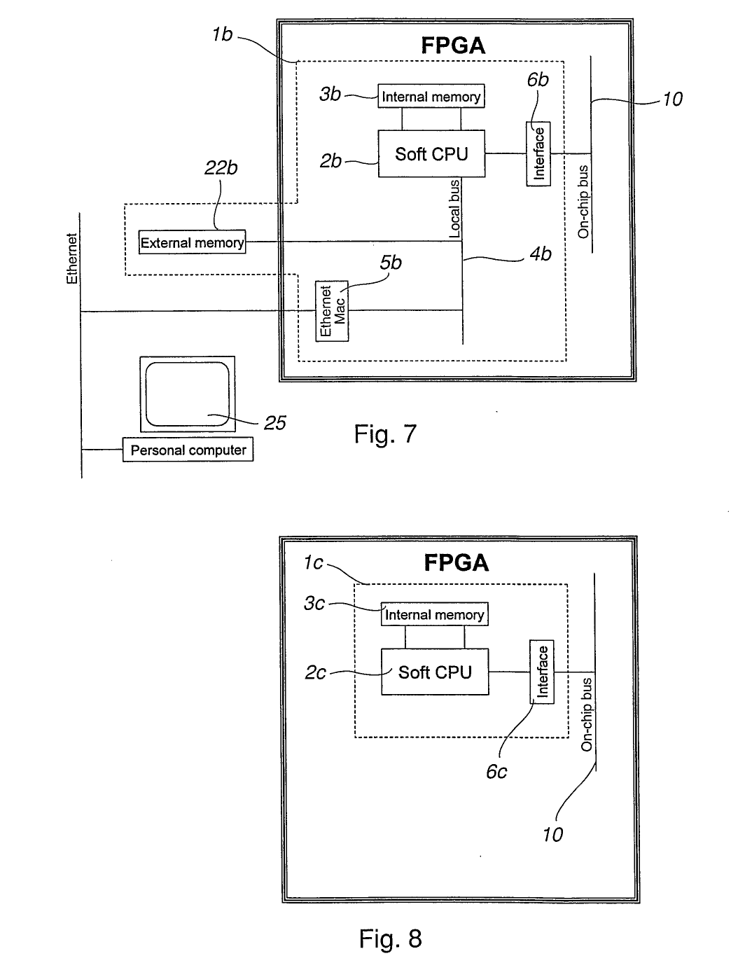

The following solution, which is a cost efficient solution, is proposed in the present invention. FIG. 7 shows an example of a functional module 1b for communication with an operator. The module 1b comprises a soft processor 2b, internal memory 3b, an interface 6b for communication with the main bus 10, a local bus 4b, and necessary IP-cores 5b for communication through e.g. Ethernet, connected to the soft processor 2b via the local bus 4b, which are all placed on the FPGA. The soft processor 2b runs different software applications for providing the user with a communication channel to the controller. The software and data for the purpose of communication with the operator, e.g. a web-server application can be stored on the internal memory 3b on the FPGA, on an external memory block 22b or on both. The operator accesses the controller by running a web-browser on an external personal computer 25.

At the simplest level of communication, the soft processor runs a web-server application. Simply a thin client then accesses the controller and the operator only needs a web-browser for achieving the communication. Although this is sufficient to exchange the information for manipulating, programming or diagnosing the system, it is not the most convenient way of communicating and programming the device. The operator accesses the controller by running an application on an external personal computer providing a user-friendly environment.

For a more user-friendly communication, an external application can be used. In that case, the soft processor will execute an application that puts it in contact with the external application run on another computer, typically a personal computer equipped with the mentioned software application. The communication can still be through TCP/IP as in the previous case, but the web-browser is replaced by the specially developed application giving the user a complete, efficient and friendly access to all available devices of the controller. The operator accesses the controller by a dedicated hardware developed for on-line manipulation of the system.

For more exclusive users, the mentioned application can be run on specially developed computers. In that case, the system is basically the same but the personal computer is replaced by an especially developed computer that for example stands the environment of a factory and/or is equipped by additional devices such as joystick for easier manipulation of the robot.

Communication through TCP/IP, in particular when only a thin client is used and html-commands must be sent, is usually time-consuming. The message that is sent is including much more information that the actual data of interest for the system. The module described here is run as a unit in parallel with other units and only the necessary data is transmitted to the controller. In this way, the communication is taking place in a user-friendly manner without any additional load to the rest of the system.

The main purpose of a control system is of course to control a process or a device. The algorithm used for the control can be very different depending on the application. For an industrial robot using permanent magnet motors the motion is controlled by at least two levels. At the higher level, first the path the robot has to follow is computed and reference data, including at least the position of each axis and often even required speed and other data, are defined. This should be done for all axes at the same time.

The reference values for each axis are then sent to typically a PID regulator where the reference position calculated according to the path planning, and sometimes even the speed, are used to find the necessary torque for each axis. The torque is then sent to the drive, which in turn runs the current-loop for each motor. Both the PID regulator and the drive need information about the position and the speed of the axis of the motor. This is measured by a suitable device and is fed back to the system.

Measurement of the position of the axis of the motor, computation of the new value of the torque and the current loop computations are time-critical issues that should not be disturbed by other events. Therefore, the processor in a one-processor system must powerful enough to make the computation complete during the required time even if maximum number of events is occurring simultaneously.

In FIG. 8 an example of functional module 1c for control of the motion of an axis is presented. The module 1c comprises a soft processor 2c, internal memory 3c, and an interface 6c for communication with the main bus 10, which are stored on an FPGA. The software and data for the purpose of communication can be stored on the internal memory 3c on the FPGA. Necessary data to the algorithm is provided and the result is made visible through the interface 6c.

This part of the controller is implemented on a separate function module in the present embodiment. A soft processor with corresponding software is used on the FPGA. The processor is in contact with the rest of the system through the interface 6c, thereby eliminating all disturbances from irrelevant communication in the system.

At each up-dating interval, the processor will be waiting for the new set of data for computation of a new value of the torque. The data might include the current position, the current speed, reference position, reference speed and all other pre-computed data the regulator requires. After that the data is provided, the processor computes the new value and makes it available for the rest of the system. The computation should be completed during the time window specified for it. The new value of the torque will be transmitted to the drive.

In an extension of the above-mentioned module, the computation normally provided by the drive can be included in the system, either in the same module or as a separate module with similar structure as explained above. According to one embodiment, the current loop and the servo-loop are combined and run on the same processor.

According to another embodiment, the position control-loop is computed as before and the output is passed to another module that computes the pulse width modulation signals. The control system comprises a separate module for the current-loop. The module for the current-loop will compute the PWM, pulse width modulation signal and makes the data available for transmission to the power circuits.

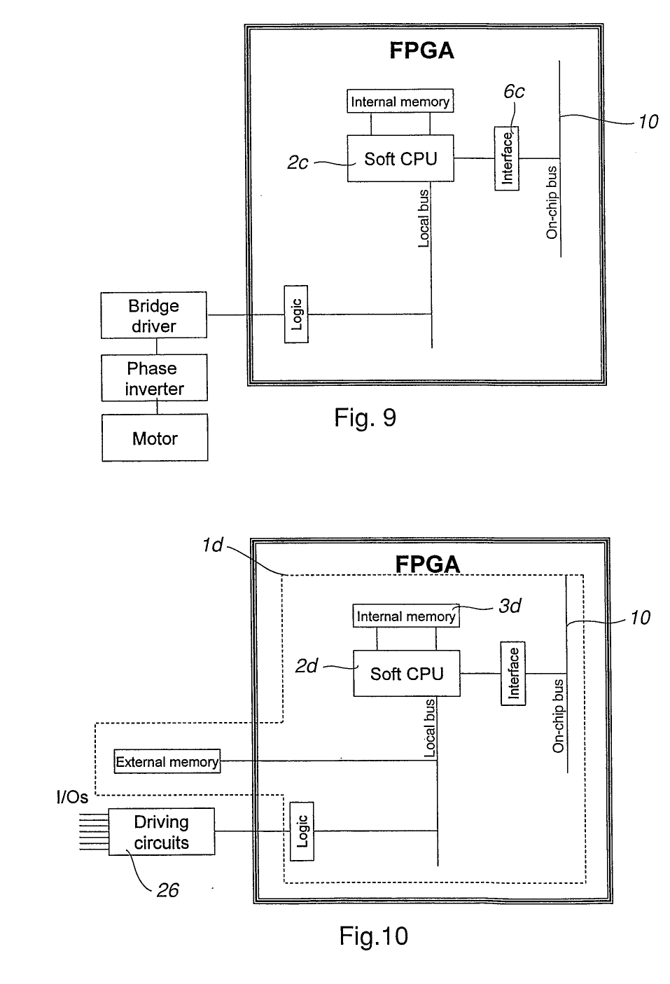

FIG. 9 shows another example of a module for control of the motion of an axis comprising internal memory, soft CPU, a logic circuit, a bridge driver, a phase inverter and motor control. In another embodiment any of the bridge driver, the phase inverter and the motor control can be implemented in one or more separate modules. The software and data for the purpose of both control and communication can be stored on the internal memory on the FPGA. Here, the computation for the current-loop is included in the same software run on the same CPU as the position control loop. Necessary data to the algorithm is provided through the interface 6c but the result is directly transmitted to the power stages. In this way, the data transmission will become a local issue increasing the performance of the system.

As a final step, one may include the position feedback to the controller with the same module. In this case, the module provides all functionality necessary for control of an axis. The module includes all necessary parts for measurement of the position of the axis, i.e. feedback to the control-loop and transfers the result directly to the power stages. Other necessary data to the algorithm is provided through the interface. A possible partition of the system could be to have separate parallel modules for all axes, which has the advantage of being easily scalable.

Use of pre-computed initial guess can increase the efficiency of the control algorithm and its speed to achieve the final position. This increases the efficiency and accuracy of the whole system. Such algorithms are often referred to as model-based control. As an example, in case of control of an axis of a robot, a mechanical model can be used to find an initial value for the value of the necessary torque in the next coming update. This value is fed to the position control resulting in a better performance. The computation necessary to find this initial guess can either be included in the module dedicated to the position control or can be put in a separate module result of which is transferred to the module for position control.

Any system use in a factory should guarantee maximum level of safety for the operators. The safety function is usually implemented by making use of at least one chain of switches that must be on for the system to operate. If during the operation, for any reasons, one of these switches is disconnected, the system should be stopped immediately in a controlled manner. The system must guarantee a maximum time under which the system in stopped. Therefore, in a one-processor system, safety tasks have a high priority.

In this embodiment, the safety system is implemented as a separate module 1d running in parallel to the rest of the system, as shown in FIG. 10. The module includes all logic necessary for the communication on the FPGA and an external memory. The rest of the system, i.e. the driving circuits 26, is implemented outside the FPGA, for example in one or more other modules. In another embodiment the module 1d may include the driving circuits. Typically, an IP-core is used for making the signals available to the system. This IP-core, denoted a logic block 5d, is located on a local bus 4d of a soft processor 3d dedicated to the safety issues. Once the processor 3d detects a signal, it might send a signal to the rest of the system indicating an urgent shutdown of the system.

A system could have a number of different types of signals with the character of the safety issues. Too high temperature detected at sensitive points and detection emergency brakes are two examples of safety events of which the latter has a higher level of urgency. Therefore, the signal from the safety module to the rest of the system can be sent in different ways. For highly urgent issues, such as emergency brakes, the module could generate an interrupt signal resulting in an immediate shutdown while other issues can be treated more softly.

Any control system with feedback includes a number of sensors measuring some quantities that are affected by the system. The measured signal can be for example a voltage that should be converted to the quantity of interest. The relation can be linear or non-linear. Also, the measured data usually need some kind of filtering. These operations are either done by a device attached to the sensor or by the receiver of the signal.

Here, it is proposed to use a general sensing module in order to measure, filter and convert data of interest and make it available to the rest of the system. The sensing module can have similar structure as the other modules using a soft CPU implemented on an FPGA. The software for data conversion and filtering will be executed on the mentioned CPU. For data that do not need any computational resources for conversion or filtering process the module can be simplified to a simple IP-core that performs the necessary operation. The sensing module includes all logic necessary for the communication on the FPGA and the rest of the system, i.e. the driving circuits are implemented outside the FPGA.

An example of the data that must be fed back to the control loop is the position of the axis of the motor for each axis. The position can be measure by different sensors such as resolvers and encoders.

Depending on the size and complexity of the sub-system to be controlled by the controller, different arrangements can be used. For sub-systems requiring control device of similar capacity as the main system, the necessary modules can be duplicated so that the subsystem will be treated as a system run in parallel to the main system. The simplest example for such a system is a robot using another robot as a co-worker.

For a sub-system of medium complexity, where for example the safety issues are not crucial and operator interface does not exist, all functions can be implemented in a single module. A larger positioner with e.g. 3 axes can be considered as such a subsystem. Another example of such system can be the process control for e.g. arc welding where control algorithms must be applied and an interaction with the main system is necessary.

If the sub-system is, for example, simply containing one or two additional axes, the control task can also be included in modules associated with the main system.

The present invention is not limited to the embodiments disclosed but may be varied and modified within the scope of the following claims. For example the number of functional modules, and the tasks they are adapted to carry out may, vary depending on the application. Not all functions of the control system have to be implemented by means of functional modules.

1. A control system adapted for real time applications, comprising means for carrying out the following functions: communication, control of a process or a device, and safety functions, the control system comprising:
a plurality of function modules (1a-1g) adapted for at least carrying out said control function and said safety functions, each function module is adapted for receiving input data and/or for providing output data, each function module is adapted to carry out a defined task based on said received input data and/or provide output data based on the task carried out, each function module is adapted to carry out the task during a time period which is independent of what is simultaneously going on in the other modules, and wherein at least one of said function modules has its logical components implemented on a programmable logic device.

2. The control system according to claim 1, wherein each function module is adapted to carry out the task during a time period which only depends on said input data.

3. The control system according to claim 1, wherein each function module comprises all components necessary for carrying out the defined task.

4. The control system according to claim 1, wherein at least one of said function modules is adapted for carrying out control of a process or a device, and at least one of said function modules is adapted for carrying out safety functions, to enable parallel processing of said safety functions and said control function.

5. The control system according to claim 1, wherein one or more of said plurality of function modules is adapted for carrying out communication with external systems and communication with an operator.

6. The control system according to claim 5, wherein at least one of said function modules is adapted for carrying out communication with external systems, and at least one of said function modules is adapted for carrying out communication with an operator, to enable parallel processing of communication with external systems and communication with an operator.

7. The control system according to claim 1, wherein said plurality of functional modules have their logical components implemented by means of programmable logic.

8. The control system according to claim 1, wherein at least one of said functional modules comprises a central processing unit and application software executing the defined task when run on the central processor unit.

9. The control system according to claim 1, wherein each of said plurality of functional modules comprises a central processing unit and application software executing the defined task when run on the central processor unit.

10. The control system according to claim 8, wherein at least one of said functional modules comprises a central processing unit implemented by means of a soft processor core implemented on said programmable logic.

11. The control system according to claim 8, wherein at least one of said functional modules comprises a central processing unit implemented by means of a hard processor core.

12. The control system according to claim 1, further comprising:
at least one field programmable gate array, wherein said programmable logic is provided on the field programmable gate array.

13. The control system according to claim 10, wherein said soft processor is implemented on said field programmable gate array, and wherein said application software is stored on the same field programmable gate array as the soft processor is implemented on.

14. The control system according to claim 1, wherein at least one of said modules is implemented by means of a state machine providing a defined output for a given input.

15. The control system according to claim 1, wherein the system is adapted for controlling an industrial robot and wherein said function modules include one or more function modules for handling position control of the motors of the robot and for handling the safety functions of the robot.

16. The control system according to claim 15, wherein said function modules include one or more function modules for planning the robot path.

17. The control system according to claim 15, wherein said function modules include one or more function modules for model-based control of the robot.

18. The control system according to claim 15, wherein said function modules include one or more function modules for producing drive signals to the motors of the robot.

19. The control system according to claim 1, wherein at least two of the function modules are located on one single chip.

20. The control system according to claim 1, wherein at least the greater part of the function modules are located on one single chip.

21. The control system according to claim 1, wherein the system comprises a main bus and the function modules are connected to the main bus.

22. The control system according to claim 21, wherein a plurality of the functional modules comprises a register unit for receiving and storing input data to the function module and for providing output data from the function module.

23. The control system according to claim 1, further comprising:
a master module adapted for controlling and supervising the function modules.

24. The control system according to claim 23, wherein the master module is adapted for controlling all communication between the function modules, thereby being responsible for providing them with input data and retrieving output data from them.

25. The control system according to claim 21, wherein the master module is connected to the main bus and the master module is adapted for controlling the communication on the main bus.

26. The control system according to claim 21, wherein the master module, the main bus and at least two of the function modules are located on one single chip.

27. The control system according to claim 1, wherein the system comprises a plurality of communication links, and wherein each function module is connected to at least one of the other function modules via one of said communication links.

28. The control system according to claim 1, wherein the control system comprises at least three function modules.

29. Use of a control system according to claim 1 for motion control.

30. Use of a control system according to claim 1 for synchronized motion control.

31. Use of a control system according to claim 1 for controlling an industrial robot.
